(19) United States
(12) Patent Application Publication
(10) Pub. No.: US 2009/0113089 A1
(43) Pub. Date: Apr. 30, 2009

(54) SOUND BOX WITH USB INTERFACE

(75) Inventors: CHANG-CHUN LIU, Shenzhen (CN); XIAO-LIN GAN, Shenzhen (CN); YU-KUANG HO, Tu-Cheng (TW)

Correspondence Address: PCE INDUSTRY, INC.;ATT. Steven Reiss, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 11/944,427

(22) Filed: Nov. 22, 2007

(30) Foreign Application Priority Data
Oct. 25, 2007 (CN) 200710202266.4

(51) Int. Cl. G06F 13/12

(52) U.S. Cl. 710/63

(57) ABSTRACT

An exemplary sound box with USB interface includes a power system and a USB interface. The power system includes a power terminal and a ground terminal. The USB interface includes a power terminal and a ground terminal corresponding to the power terminal and a ground terminal of the power system respectively, wherein the power terminal or the ground terminal is connected to the corresponding terminal of the sound box via a rheostat. A voltage received by the power system from the USB interface can be adjusted by the rheostat.

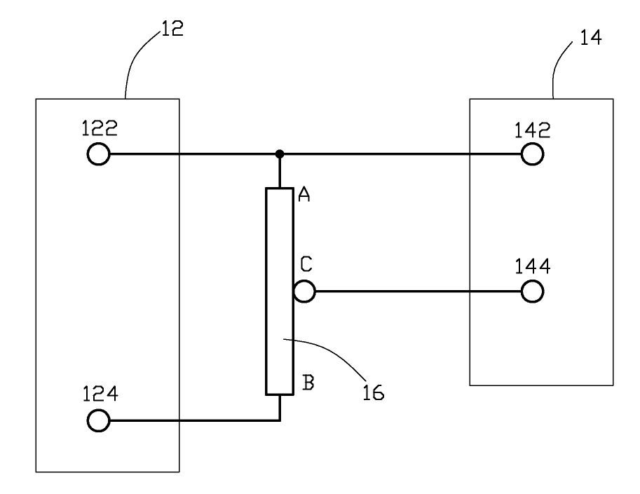

### BACKGROUND

1. Field of the Invention

The present invention relates to sound boxes, and particularly to a sound box with USB interface.

2. Description of Related Art

Conventionally, many different interfaces are arranged in a computer chassis, for example USB interface, VGA interface, audio interface, and so on. These interfaces are arranged in the computer chassis for different purposes and each has a special standard. For example, the USB interface allows peripherals to be connected using a single standardized interface socket and improves plug-and-play capabilities by allowing devices to be connected and disconnected without rebooting the computer.

An ordinary sound box usually defines an audio interface to couple with a computer for transmitting audio signals and a power plug to plug in an electric outlet for getting power. A new structure design of the sound box is provided to make it easy to use, which defines an audio interface to couple with a computer for transmitting audio signals, and a USB interface to couple with the computer for getting power. But the USB interface of the computer only supplies 5V DC power, therefore some sound boxes that have a rated voltage of under 5V (such as 2.5V sound box) cannot use the USB interface of the computer to get power.

### SUMMARY

An exemplary sound box with USB interface includes a power system and a USB interface. The power system includes a power terminal and a ground terminal. The USB interface includes a power terminal and a ground terminal corresponding to the power terminal and a ground terminal of the power system respectively, wherein the power terminal or the ground terminal is connected to the corresponding terminal of the sound box via a rheostat.

Other advantages and novel features of the present invention will become more apparent from the following detailed description of preferred embodiment when taken in conjunction with the accompanying drawing, in which:

### BRIEF DESCRIPTION OF THE DRAWINGS

The drawing is an isometric view of a sound box with USB interface in accordance with the present invention.

### DETAILED DESCRIPTION

Referring to the drawing, a sound box with USB interface in accordance with an embodiment of the present invention includes a USB interface 12, a power system 14, and a sliding rheostat 16. The USB interface 12 includes a power terminal 122 and a ground terminal 124. The power system 14 includes a power terminal 142 and a ground terminal 144. The sliding rheostat 16 includes a first end A coupled with the power terminals 122 and 124 of the USB interface 12 and the power system 14, a second end B coupled with the ground terminal 124 of the USB interface 12, and an adjusting end C coupled with the ground terminal 144 of the power system 14.

In this embodiment of the invention, the sliding rheostat 16 is arranged in a chassis of the sound box. In a second embodiment of the invention, the USB interface 12 is coupled with the power system 14 via a cable, the sliding rheostat 16 is mounted on the cable.

Therefore, when the USB interface 12 of the sound box is coupled with a USB interface of a computer, power adjusted to the rating of the sound box is supplied.

The foregoing description of the exemplary embodiments of the invention has been presented only for the purposes of illustration and description and is not intended to be exhaustive or to limit the invention to the precise forms disclosed. Many modifications and variations are possible in light of the above teaching. The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A sound box with USB interface comprising:
a power system having a power terminal and a ground terminal; and
a USB interface having a power terminal and a ground terminal corresponding to the power terminal and a ground terminal of the power system respectively,
wherein the power terminal or the ground terminal of the USB interface is connected to the corresponding terminal of the sound box via a rheostat.

2. The sound box as claimed in claim 1, wherein the rheostat is a sliding rheostat with a first end coupled with the power terminals of the USB interface and the power system, a second end coupled with the ground terminal of the USB interface, and an adjusting end coupled with the ground terminal of the power system.

3. The sound box as claimed in claim 1, wherein rheostat is arranged in a chassis of the sound box.

4. The sound box as claimed in claim 1, wherein the sound box further includes a cable to couple the power system with the USB interface, the rheostat is mounted on the cable.
